(19) United States
(12) Patent Application Publication
(10) Pub. No.: US 2026/0010407 A1
(43) Pub. Date: Jan. 8, 2026

(54) DEVICE AND METHOD WITH MEMORY OPERATION EVALUATION AND ACCELERATION

(71) Applicant: Samsung Electronics Co., Ltd., Suwon-si (KR)

(72) Inventors: Xiao LAN, Xi’an (CN); Mao CHEN, Xi’an (CN); Yuehua DAI, Xi’an (CN); Deok Jae OH, Suwon-si (KR); Liyuan ZHANG, Xi’an (CN)

(73) Assignee: Samsung Electronics Co., Ltd., Suwon-si (KR)

(21) Appl. No.: 19/258,664

(22) Filed: Jul. 2, 2025

(30) Foreign Application Priority Data
Jul. 2, 2024 (CN) 202410883132.7
Feb. 19, 2025 (KR) 10-2025-0021478

(51) Int. Cl. G06F 9/50

(52) U.S. Cl. CPC G06F 9/5044; G06F 9/5016; G06F 9/5088; G06F 2209/508; G06F 2209/509

(57) ABSTRACT

A method of accelerating a memory operation of an electronic device, performed by a processor, and a method of evaluating the method are disclosed. The method of accelerating the memory operation of the electronic device, performed by the processor, includes determining whether to offload the memory operation to a memory device based on a memory size corresponding to the memory operation, in response to detecting the memory operation, generating instructions corresponding to the memory operation in response to determining to offload the memory operation to the memory device, transmitting the instructions to the memory device, and receiving, from the memory device, an execution result corresponding to the memory operation performed based on the instructions.

### CROSS-REFERENCE TO RELATED APPLICATIONS

This application claims the benefit under 35 USC § 119(a) of Chinese Patent Application No. 202410883132.7, filed on Jul. 2, 2024, in the China National Intellectual Property Administration, and Korean Patent Application No. 10-2025-0021478, filed on Feb. 19, 2025, in the Korean Intellectual Property Office, the entire disclosures of which are incorporated herein by reference for all purposes.

### BACKGROUND

### 1. Field

The following description relates to a field of computer technology, and more particularly, to a method and device with memory operation evaluation and acceleration.

### 2. Description of Related Art

In a computing system, a memory operation is an essential process that includes data storage, retrieval, and transmission and may directly affect the overall performance and response speed of a system. In traditional memory architecture, a processor (e.g., a central processing unit (CPU)) can directly perform most memory-related tasks. However, when memory-related tasks are performed using only a processor, memory bandwidth limitations and latency problems may occur as mass data and transmission computational demands increase. Various technologies are being developed in high-performance computing and data centers to optimize memory access and distribute a load. For example, a method of accelerating a memory computation using a computer express link (CXL)-based memory device and direct memory access (DMA) technology or reducing a load on a processor by offloading a memory operation to a certain accelerator is being studied.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method of accelerating a memory operation, performed by a processor, includes determining whether to offload the memory operation to a memory device based on a memory size corresponding to the memory operation, in response to detecting the memory operation, generating instructions corresponding to the memory operation in response to determining to offload the memory operation to the memory device, transmitting the instructions to the memory device, and receiving, from the memory device, an execution result corresponding to the memory operation performed based on the instructions.

The memory operation may include a computing express link (CXL) memory operation, and the memory device may include a CXL memory device.

The determining of whether to offload the memory operation to the memory device based on the memory size corresponding to the memory operation may include determining whether the memory size corresponding to the memory operation exceeds a first threshold value and offloading the memory operation to the memory device in response to the memory size corresponding to the memory operation exceeding the first threshold value.

The method may further include determining whether to offload a second memory operation to the memory device based on a memory size corresponding to the second memory operation, in response to detecting the second memory operation; wherein the second memory operation comprises a computing express link (CXL) memory operation, and the memory device comprises a CXL memory device; wherein the determining of whether to offload the memory operation to the memory device based on the memory size corresponding to the second memory operation comprises: determining whether the second memory size corresponding to the second memory operation exceeds the first threshold value; and determining to not offload the second memory operation to the memory device in response to the memory size corresponding to the second memory operation being less than or equal to the first threshold value; and determining to not offload the second memory operation to the memory device in response to the memory size corresponding to the second memory operation being less than or equal to the first threshold value.

The generating of the instructions corresponding to the memory operation may include evaluating a batch flag to select between (i) generating first processing instructions corresponding to batch processing the memory operation, based on the batch flag corresponding to the memory operation having a first flag value, and (ii) generating second processing instructions corresponding to not batch processing the memory operation, based on the batch flag corresponding to the memory operation having a second flag value; and generating an offload mode flag that determines an offload mode for each of the processor and the memory device of the memory operation.

The generating of the offload mode flag may include determining whether the memory size corresponding to the memory operation exceeds a second threshold value, evaluating the memory size against the second threshold to select between: (i) when the memory size corresponding to the memory operation exceeds the second threshold value, determining that the memory device is to use a first offload mode in response to offloading the memory operation to the memory device and generating a first offload mode flag value corresponding to the memory operation, and (ii) when the memory size corresponding to the memory operation is less than or equal to the second threshold value, determining that the memory device is to use a second offload mode in response to offloading the memory operation to the memory device and generating a second offload mode flag value corresponding to the memory operation.

The transmitting of the instructions to the memory device may include: evaluating the batch flag to select between: (i) transmitting, to the memory device, the first processing instructions and the offload mode flag based on the batch flag corresponding to the memory operation having the first flag value, and (ii) transmitting, to the memory device, the second processing instructions and the offload mode flag based on the batch flag corresponding to the memory operation having the second flag value.

The receiving, from the memory device, of the execution result corresponding to the memory operation performed based on the instructions may include receiving, by the memory device, the instructions corresponding to the memory operation from the processor, acquiring, by the memory device, a first execution result by executing the memory operation in an asynchronous mode, when the instructions include a first offload mode flag value, acquiring, by the memory device, a second execution result by executing the memory operation in a synchronous mode, when the instructions including a second offload mode flag value, and receiving, by the processor, either the first execution result or the second execution result.

The method may further include acquiring decoding instructions corresponding to the memory operation, based on the memory device decoding the instructions corresponding to the memory operation, in which the acquiring, by the memory device, of the first execution result by executing the memory operation in the asynchronous mode may include executing, by the memory device, the asynchronous mode based on the decoding instructions, and the acquiring, by the memory device, of the second execution result by executing the memory operation in the synchronous mode may include executing, by the memory device, the synchronous mode based on the decoding instructions.

The acquiring of the decoding instructions corresponding to the memory operation may include, based on the instructions corresponding to the memory operation including first processing instructions, acquiring encoding instructions corresponding to the memory operation by batch processing the first processing instructions, and acquiring the decoding instructions corresponding to the memory operation by decoding the encoding instructions by the memory device.

The acquiring of the decoding instructions corresponding to the memory operation may include, based on the instructions corresponding to the memory operation including second processing instructions, acquiring the decoding instructions corresponding to the memory operation by decoding the second processing instructions by the memory device.

The memory operation may include a CXL memory operation, and the memory device may include a CXL memory device.

The method may further include evaluating a system configured to perform the method, the system including the processor and the memory device and configured to perform the method, in which the evaluating of the system may include determining a first ratio of an execution time of target system functions to an execution time of system functions and a second ratio of an execution time of accelerated functions among the target system functions to an execution time of all the system functions, acquiring a frequency coefficient of the processor, system memory pressure, and acceleration coefficients of the accelerated functions, determining a third ratio based on the first ratio, the second ratio, and the acceleration coefficients of the accelerated functions, and determining a result of multiplication of the frequency coefficient of the processor, the system memory pressure, and the third ratio to be an acceleration ratio of the memory operation performed by the system.

In another general aspect, a non-transitory computer-readable storage medium storing instructions, wherein the instructions, when executed by a computing device, cause the computing device to perform a process comprising: in response to detecting a memory operation, determining whether to offload the memory operation to a memory device based on a memory size corresponding to the memory operation, generating instructions corresponding to the memory operation in response to determining to offload the memory operation to the memory device, transmitting the instructions to the memory device, and receiving, from the memory device, an execution result corresponding to the memory operation performed based on the instructions.

In still another general aspect, an electronic device for accelerating a memory operation based on a processor includes an offload determinator configured to determine whether to offload the memory operation to a memory device based on a memory size corresponding to the memory operation, in response to detecting the memory operation, an instruction generator configured to generate instructions corresponding to the memory operation in response to determining to offload the memory operation to the memory device, an instruction transmitter configured to transmit the instructions to the memory device, and a result receiver configured to receive, from the memory device, an execution result corresponding to the memory operation performed based on the instructions.

The offload determinator may be configured to determine whether the memory size corresponding to the memory operation exceeds a first threshold value and is configured to offload the memory operation to the memory device in response to the memory size corresponding to the memory operation exceeding the first threshold value.

The process may further comprise: determining whether to offload a second memory operation to the memory device based on a memory size corresponding to the second memory operation, in response to detecting the second memory operation; wherein the second memory operation comprises a computing express link (CXL) memory operation, and the memory device comprises a CXL memory device; wherein the determining of whether to offload the memory operation to the memory device based on the memory size corresponding to the second memory operation comprises: determining whether the second memory size corresponding to the second memory operation exceeds the first threshold value; and the offload determinator may be further configured to determine to not offload the second memory operation to the memory device in response to the memory size corresponding to the memory operation being less than or equal to the first threshold value.

The instruction generator may be configured to: evaluate a batch flag to select between: (i) generating first processing instructions corresponding to batch processing the memory operation, based on the batch flag corresponding to the memory operation having a first flag value, and generating (ii) second processing instructions corresponding to not batch processing the memory operation, based on the batch flag corresponding to the memory operation having a second flag, and wherein the instruction generator is further configured to generate an offload mode flag that determines an offload mode for each of the processor and the memory device of the memory operation.

The instruction generator may be configured to determine whether the memory size corresponding to the memory operation exceeds a second threshold value, and evaluate the memory size against the second threshold to select between: (i) when the memory size corresponding to the memory operation exceeds the second threshold value, determine that the memory device is to use a first offload mode in response to offloading the memory operation to the memory device and generate a first offload mode flag value corresponding to the memory operation, and (ii) when the memory size corresponding to the memory operation is less than or equal to the second threshold value, determine that the memory device uses a second offload mode in response to offloading the memory operation to the memory device and generate a second offload mode flag value corresponding to the memory operation.

The electronic device may further include a memory device, in which the memory device may include an instruction receiver configured to receive, from the processor, the instructions corresponding to the memory operation, an asynchronous executor configured to acquire, by the memory device, a first execution result by executing the memory operation in an asynchronous mode, when the instructions include a first offload mode flag value, a synchronous executor configured to acquire, by the memory device, a second execution result by executing the memory operation in a synchronous mode, when the instructions include a second offload mode flag value, and a result transmitter configured to transmit, to the processor, either the first execution result or the second execution result.

Other features and aspects will be apparent from the following detailed description, the drawings, and the claims.

### BRIEF DESCRIPTION OF THE DRAWINGS

FIG. 1 illustrates an example of a method of accelerating a memory operation by an electronic device, according to one or more embodiments.

FIG. 2 illustrates an example of a method of accelerating a memory operation by an electronic device, according to one or more embodiments.

FIG. 3 illustrates an example of a method of evaluating the memory operation acceleration of an electronic device, according to one or more embodiments.

FIG. 4 illustrates an example of a device for accelerating a memory operation, according to one or more embodiments.

FIG. 5 illustrates an example of an electronic device for accelerating a memory operation, according to one or more embodiments.

FIG. 6 illustrates an example of an electronic device, according to one or more embodiments.

FIG. 7 illustrates an example of an electronic device including a processor and a memory device, according to one or more embodiments.

FIG. 8 illustrates an example of an electronic device, according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

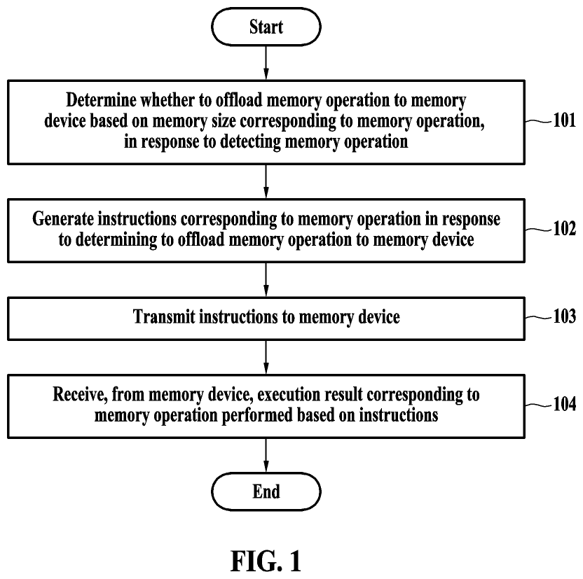

FIG. 1 illustrates an example of a method of accelerating a memory operation by an electronic device, according to one or more embodiments.

To aid in understanding of FIG. 1, generally, there may be three decisions made in carrying out the memory operation. First, there may be an offload decision, that is, whether to offload instructions for the memory operation to a memory device. Second, when offloaded instructions are to be configured for batch processing or not. And third, which mode (e.g. asynchronous/synchronous) the memory device will use when carrying out offloaded instructions.

An electronic device (e.g., a system or a non-transitory computer-readable storage medium) may accelerate a memory operation. For example, the electronic device may accelerate the memory operation by distributing (i) a computation corresponding to the memory operation to be performed by a processor and (ii) a computation corresponding to the memory operation to be performed by a memory device (that is, determining where the memory operation will be performed). The method of accelerating a memory operation, as described with reference to FIG. 1, may be executed by a processor (e.g., a central processing unit (CPU)) included in the electronic device. Methods of accelerating the memory operation, as performed by the electronic device, are now described in detail.

Referring to FIG. 1, in operation 101, the electronic device may determine whether to offload the memory operation to a memory device based on a memory size corresponding to the memory operation, in response to detecting the memory operation. For example, the memory device may be a computing express link (CXL) memory device. For example, the memory operation may include any of various CXL memory operations. For example, the memory operation may include, but is not limited thereto, a memory copy (memcpy), a memory set (memset) that initializes a predetermined region in a memory, or an in-memory computation. In some implementations, these memory operations may have a memory size parameter value (e.g., an amount of memory to be copied or set), and the memory size may be obtained from that memory size parameter value. The electronic device may improve the speed of the entire memory operation based on the CXL memory operation and the CXL memory device.

In operation 101, the electronic device may determine whether the memory size corresponding to the memory operation exceeds a first threshold value. For example, the electronic device may offload the memory operation to the memory device when the memory size corresponding to the memory operation exceeds the first threshold value. For example, the electronic device may determine not to offload the memory operation to the memory device when the memory size corresponding to the memory operation is less than or equal to the first threshold value. That is, the memory operation may be offloaded when the size thereof is sufficiently large. Accordingly, the electronic device may maximize the execution efficiency of a system function. For example, the first threshold value may represent a threshold value of the memory size of the memory operation. The first threshold value may be referred to in short as mem_offload_threshold. The first threshold value may be predetermined by a user or an external device. For example, the electronic device may offload the memory operation to the memory device (e.g., a CXL memory device) when the memory size corresponding to the memory operation exceeds the mem_offload_threshold. In another example, the electronic device may execute the memory operation in the processor (e.g., a CPU) and not offload the memory operation to the memory device (e.g., a CXL memory device) when the memory size corresponding to the memory operation is less than or equal to the mem_offload_threshold.

In operation 102, the electronic device may generate instructions corresponding to the memory operation in response to determining to offload the memory operation to the memory device.

For example, the electronic device may determine a batch flag corresponding to the memory operation. The batch flag may be set by a user or predetermined by an external device. For example, the batch flag may be used to determine whether the electronic device performs batch processing on the memory operation. For example, the batch flag may have a value of true or false. The electronic device may determine/set the batch flag based on the memory size corresponding to the memory operation, the computational complexity of the memory operation, or the current load state of the electronic device (the latter factors are described below). For example, the electronic device may generate first processing instructions for batch processing the memory operation, based on the batch flag being a first flag value (e.g., true). In another example, the electronic device may generate second processing instructions corresponding to not batch processing the memory operation, based on the batch flag having a second flag value (e.g., false). Additionally, the electronic device may generate an offload mode flag value that determines an offload mode corresponding to each of the processor and the memory device of the memory operation. Accordingly, the electronic device may minimize overhead occurring when offloading the memory operation by determining whether to perform batch processing on the memory operation (e.g., a CXL memory operation) based on a value of the batch flag. The batch flag may be referred to in short as mem_batch_flag. For example, the processor (e.g., a CPU) may first generate instructions for batch processing the memory operation and then transmit the instructions to the memory device (e.g., a CXL memory device) when the mem_batch_flag is set to true. The memory device may generate non-batch processing instructions (also referred to as general instructions) by executing batch processing on the first instructions and may decode the non-batch processing instructions (general instructions) produced by executing the first/batch-based instructions. In another example, the processor (e.g., a CPU) may first generate general instructions and then transmit the general instructions to the memory device (e.g., a CXL memory device) when the mem_batch_flag is set to false. The memory device (e.g., a CXL memory device) may then directly decode and execute the general instructions (here, directly means without having to generate its own non-batch instructions to carry out the memory operation).

In operation 102, in the case of offloading to the memory device, and regardless of whether the offloaded instructions are for batch mode or non-batch mode, for the purpose of determining how the memory device is to carry out the offloaded instructions (e.g., whether to carry them out asynchronously or not) the electronic device may determine whether the memory size corresponding to the memory operation exceeds a second threshold value (distinct from the first threshold value). For example, when the memory size corresponding to the memory operation exceeds the second threshold value, the electronic device may determine that the memory device is to use a first offload mode (e.g., an asynchronous mode) when offloading the memory operation to the memory device and generate a first offload mode flag corresponding to the memory operation. When the memory size corresponding to the memory operation is less than or equal to the second threshold value, the electronic device may determine that the memory device is to use a second offload mode (e.g., a synchronous mode) when offloading the memory operation to the memory device and generate a second offload mode flag value for the memory operation. Accordingly, the electronic device may save the resources of the processor (e.g., a CPU) as much as possible by selecting the synchronous mode or the asynchronous mode when offloading the memory operation to the memory device (e.g., a CXL memory device) depending on the memory size corresponding to the memory operation. The second threshold value may also be referred to as mem_mode_threshold. The second threshold value may be predetermined by a user or another device. For example, the electronic device may perform the memory operation in the asynchronous mode when the memory size corresponding to the memory operation exceeds the mem_mode_threshold and may perform the memory operation in the synchronous mode when the memory size is less than or equal to the mem_mode_threshold.

For reference, the memory operation may be performed by a dynamic random-access memory device (DRAM, or some other form of host memory) or the memory device (e.g., a CXL memory device). There may be a linear relationship between (i) the memory size and (ii) the difference in overall/system performance between using the DRAM the memory device to perform the memory operation or using the CXL memory device (for example) to perform the memory operation; generally, the larger the memory size, the larger the overall/system performance difference between use of the two memory devices. For example, when the memory size corresponding to the memory operation is small, the difference in computational performance (e.g., computational performance based on a system function) of the electronic device (e.g., a system) may be insignificant. Additionally, when the memory size corresponding to the memory operation is small, the electronic device may spend relatively more time on non-memory operations (e.g., a logic computation of the CPU) than on the memory operation. In this case, the speed may be insignificantly improved (or even degraded, due to overhead) when the electronic device uses a solution to accelerate the memory operation. Accordingly, the electronic device may determine whether to perform the memory operation using only the processor (and host memory) or to offload the memory operation to the memory device based on the memory size corresponding to the memory operation. The first threshold value (e.g., mem_offload_threshold) of the memory size may be set to a different value depending on an operating system or other details of the system.

Following are additional details of selecting between the synchronous and asynchronous modes. As noted, the electronic device may offload the memory operation to the memory device (e.g., a CXL memory device) when the memory size corresponding to the memory operation is large. When the electronic device performs the memory operation in fully synchronous mode, the resources of the processor (e.g., a CPU) may be wasted (e.g., idle time) until the result is returned. When the electronic device performs the memory operation in fully asynchronous mode, the context switching cost at the CPU induced by the asynchronous mode may also be relatively large. Accordingly, the electronic device may select between the synchronous mode or the asynchronous mode depending on the memory size. For example, the second threshold value (e.g., mem_mode_threshold) corresponding to the memory size may be set to a different value depending on an operating system or other factors.

In operation 103, when it has been determined to offload the memory operation to the memory device, the electronic device may transmit the instructions corresponding to the memory operation to the memory device.

For example, the electronic device may transmit the first processing instructions (e.g., batch based instructions) and the offload mode flag (e.g., synchronous/asynchronous flag) to the memory device based on the batch flag (which corresponds to the memory operation) having the first flag value, for transmitting the instructions corresponding to the memory operation to the memory device. Additionally, the electronic device may transmit the second processing instructions and the offload mode flag to the memory device based on the batch flag corresponding to the memory operation having the second flag value. Accordingly, the electronic device may transmit either the batch (first) processing instructions or the general (second) instructions from the processor to the memory device so that the memory device may execute the memory operation.

In operation 104, the electronic device may receive, from the memory device, an execution result corresponding to the memory operation performed based on the instructions. For example, when the electronic device includes the processor and the memory device as separate physical hardware, the processor (e.g., a CPU) may receive the execution result corresponding to the memory operation from the memory device.

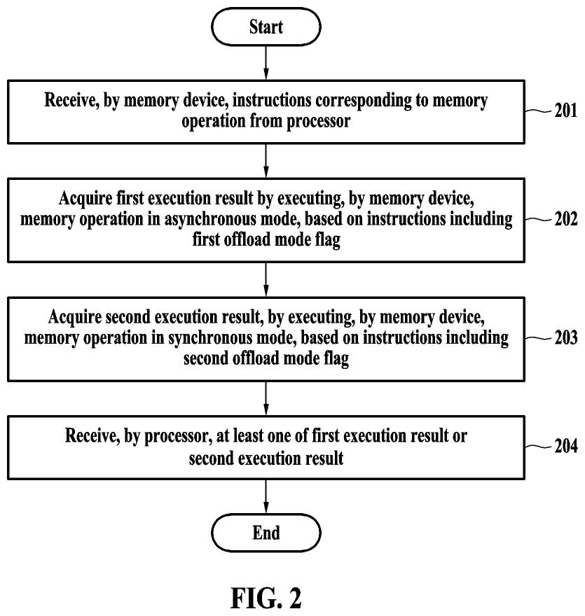

FIG. 2 illustrates an example of a method of accelerating a memory operation by an electronic device, according to one or more embodiments. The memory operation acceleration method of FIG. 2 may be executed by either a memory device included in the electronic device (or in some implementations, a remote memory device accessed via a distributed memory system, e.g., a distributed memory system) or may be executed by a memory operation accelerator (e.g., an in-memory computing (IMC) device) in the memory device that communicates with the electronic device in a wired and/or wireless manner. However, examples are not limited thereto. In the following description “the memory device” refers to either of the aforementioned memory devices.

In operation 201, the electronic device may cause the memory device to receive instructions corresponding to the memory operation from a processor (e.g., a CPU).

For example, after operation 201, the electronic device may acquire, through the memory device, decoding instructions corresponding to the memory operation, based on decoding the instructions corresponding to the memory operation (i.e., the memory device may decode the instructions it receives and execute the decoded instructions). That is, the memory device may execute the decoding instructions by decoding the instructions received from the processor and execute the decoded instructions.

For example, based on the instructions corresponding to the memory operation received from the processor (the instructions including at least first processing instructions), the memory device may acquire (e.g., generate) encoding instructions corresponding to the memory operation by batch processing the first processing instructions. The memory device may acquire decoding instructions corresponding to the memory operation by decoding (e.g., executing) the encoding instructions. That is, the electronic device may improve the execution speed of the memory device by determining whether to perform batch processing by the memory device, and the determining may depend on whether batch processing is performed by the processor (e.g., a CPU).

In the case where the memory receives instructions including the second instructions, based thereon, the memory device may acquire decoding instructions corresponding to the memory operation by decoding the second processing instructions. That is, the electronic device may improve the execution speed of the memory device by determining whether to perform batch processing by the memory device depending on whether batch processing is performed by the processor (e.g., a CPU).

For example, the memory operation may be a CXL memory operation, and the memory device may be a CXL memory device. The memory operation and the memory device are described in detail with reference to FIG. 1.

In operation 202, the electronic device may acquire a first execution result by executing, by the memory device, the memory operation in an asynchronous mode; the executing in the asynchronous mode may be based on the received instructions (corresponding to the memory operation) including a first offload mode flag value.

For example, in the electronic device, the memory device may execute the asynchronous mode based on the decoding instructions.

In operation 203, the electronic device may acquire a second execution result by executing, by the memory device, the memory operation in a synchronous mode, based on the instructions corresponding to the memory operation transmitted to the memory device, the transmitted instructions including a second offload mode flag value.

Although not depicted in FIG. 2, generally, for one memory operation, either operation 202 or operation 203 will be executed, depending on the offload mode flag.

The electronic device may execute the synchronous mode based on the decoding instructions of the memory operation based on the memory device.

In operation 204, the electronic device may accelerate the memory operation by transmitting, to the processor, the first execution result or the second execution result (as the case may be) of the memory operation through the memory device. As described above, the processor may determine/set a value of an offload mode flag according to a memory size of the memory operation. The electronic device may minimize the cost of offloading the memory operation by selecting either the synchronous mode or the asynchronous mode when offloading the memory operation to the memory device; the offloading may be based on the offload mode flag.

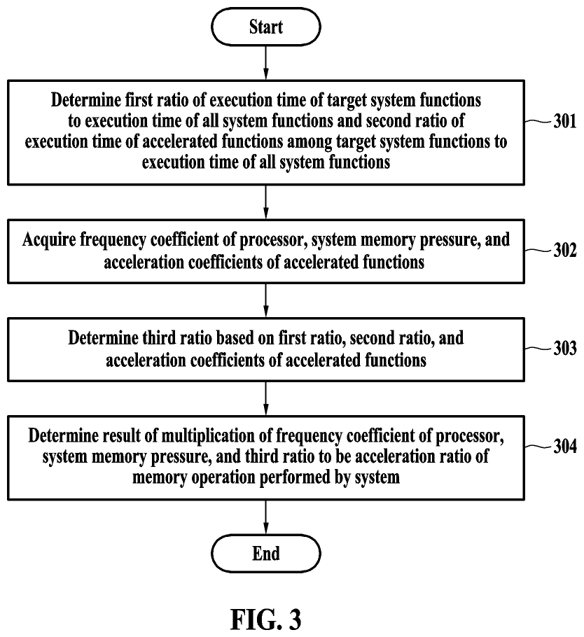

FIG. 3 illustrates an example of a method of evaluating the memory operation acceleration of an electronic device, according to one or more embodiments.

Referring to FIG. 3, in operation 301, the electronic device (e.g., a system) may determine a first ratio of (i) an execution time of target system functions related to a memory operation to (ii) an execution time of all functions (e.g., all system functions) included in a system. The electronic device may also determine a second ratio of (i) an execution time of accelerated functions among the target system functions to (ii) an execution time of all the functions.

In operation 302, the electronic device may acquire a frequency coefficient (e.g., a clock speed) of a processor (e.g., a CPU), system memory pressure, and acceleration coefficients corresponding to the accelerated functions.

In operation 303, the electronic device may determine a third ratio based on the first ratio, the second ratio, and the acceleration coefficients corresponding to the accelerated functions.

For example, the electronic device may determine the third ratio based on Equation 1 below.

$$Third Ratio = \frac{1}{1 - ( 1 - \frac{1}{∝} ) * {ratio}_{sys \_ func} * {ratio}_{mem \_ op}} \qquad Equation 1$$

In Equation 1, ratio_{sys_func} denotes a first ratio, ratio_{mem_op} denotes a second ratio, and ∝ denotes an acceleration coefficient of an accelerated function. The first ratio may be defined as ratio_{sys_func} ∈[0,1). The second ratio may be defined as ratio_{mem_op}∈[0,1). Here, ∝ may be defined by Equation 2 below.

$$∝ = \frac{{t}_{ori \_ mem \_ op}}{{t}_{acc \_ mem \_ op}} , ∝ ∈ ( 0 , + ∞ ) \qquad Equation 2$$

In Equation 2, t_{ori_mem_op}=tₒᵣᵢ−t_{ori_other}, t_{acc_mem_op}=t_{acc}=t_{acc_other}, and t_{acc_other}=t_{ori_other}. Here, t_{ori_mem_op} denotes an execution time of an accelerated function before acceleration and tₒᵣᵢ denotes the total execution time of all functions before accelerating the accelerated function. In addition, t_{ori_other} denotes an execution time of functions other than accelerated functions among all functions before acceleration. t_{acc_menm_op} denotes an execution time after accelerating the accelerated function, t_{acc} denotes the total execution time of all functions after accelerating the accelerated function, and t_{acc_other} denotes an execution time of functions other than the accelerated functions among all functions after accelerating the accelerated function.

In operation 304, the electronic device may determine a result of the multiplication of the frequency coefficient of the processor (e.g., a CPU), the system memory pressure, and the third ratio to be an acceleration ratio of the memory operation of the electronic device (e.g., a system). For example, the acceleration ratio of the memory operation of the system may be in direct ratio to the frequency coefficient of the processor (e.g., a CPU) and the system memory pressure.

For example, the memory operation may include, but is not limited thereto, a memory copy task and/or a memory set task.

The electronic device may evaluate the memory operation acceleration by considering the following four variables. For example, the electronic device may evaluate the memory operation acceleration performed by the electronic device (e.g., a system) by considering the first ratio (e.g., ratio_{sys_func}∈[0,1)) of the execution time of the target system functions related to the memory operation to the execution time of all functions included in the system, the second ratio (e.g., ratio_{mem_op}∈[0,1)) of the execution time of the accelerated functions (e.g., a function corresponding to a memory copy and a function corresponding to a memory set) among the target system functions to the execution time of all functions included in the system, the frequency coefficient (e.g., f(cpu_freq)) of the processor (e.g., a CPU), and the system memory pressure (e.g., f(mem)).

The electronic device may consider the following predetermined variables in addition to the four variables described above. For example, the electronic device may express the acceleration coefficients of the accelerated functions (e.g., a function corresponding to a memory copy and a function corresponding to a memory set) as Equation 2 above, express the total execution time of the system before acceleration as tₒᵣᵢ=(t_{ori_other}+t_{ori_mem_op}), and express the total execution time of the system after acceleration as t_{acc}=t_{acc_other}+t_{acc_mem_op}). For reference, since the electronic device applies the memory operation acceleration method based on the descriptions provided with reference to FIGS. 1 and 2 only to the accelerated functions (e.g., a memory set and a memory copy), the execution time of unaccelerated functions (e.g., t_{ori_other}) of the system before acceleration and the execution time of unaccelerated functions (e.g., t_{acc_other}) of the system after acceleration may be defined as t_{acc_other}=t_{ori_other}. For reference, the electronic device, based on Amdahl's Law, may define the acceleration ratio of the memory operation of the system by Equation 3 below.

$$speedup = \frac{{t}_{ori}}{{t}_{acc}} = \frac{{t}_{{ori}_{other}} + {t}_{{ori}_{{mem}_{op}}}}{{t}_{{acc}_{other}} + {t}_{{acc}_{{mem}_{op}}}} = \frac{{t}_{{ori}_{other}} + {t}_{{ori}_{{mem}_{op}}}}{{t}_{{ori}_{other}} + \frac{{t}_{{ori}_{{mem}_{op}}}}{∝}} = f ( cpu\_freq ) * f ( mem ) * \frac{\begin{matrix}( 1 - {ratio}_{sys \_ func} * {ratio}_{mem \_ op} ) * {t}_{ori} + \\ {ratio}_{sys \_ func} * {ratio}_{mem \_ op} * {t}_{ori}\end{matrix}}{\begin{matrix}( 1 - {ratio}_{sys \_ func} * {ratio}_{mem \_ op} ) * {t}_{ori} + \\ \frac{{ratio}_{sys \_ func} * {ratio}_{mem \_ op} * {t}_{ori}}{∝}\end{matrix}} \qquad Equation 3$$

Equation 3 may be simplified and expressed as Equation 4 below.

$$speedup = f ( cpu\_freq ) * f ( mem ) * \frac{1}{1 - ( 1 - \frac{1}{∝} ) * {ratio}_{sys \_ func} * {ratio}_{mem \_ op}} \qquad Equation 4$$

The method of evaluating the memory operation acceleration of the electronic device illustrated in FIG. 3 may be applied to the evaluation of the memory operation acceleration implemented through any operating system.

The method of accelerating the memory operation of the electronic device and the method of evaluating the memory operation acceleration of the electronic device are described with reference to FIGS. 1 to 3.

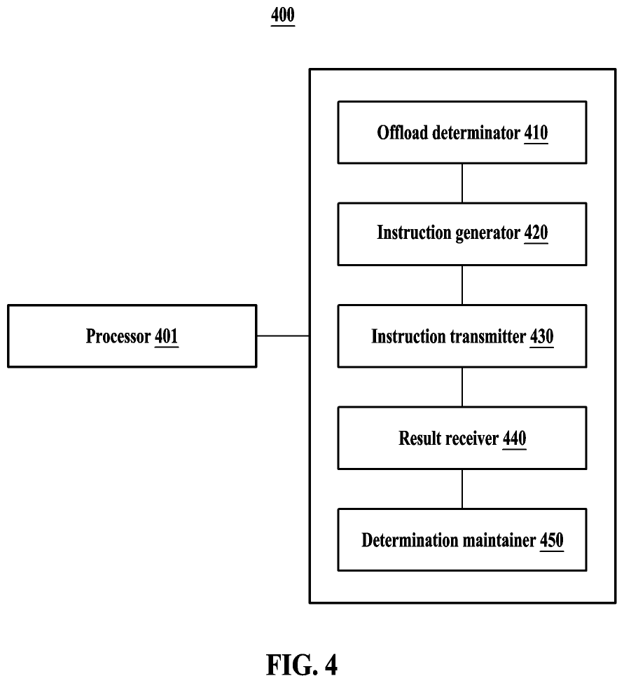

Next, a structure of the electronic device (e.g., a system) that accelerates the memory operation and evaluates the memory operation acceleration is described in detail with reference to FIGS. 4 to 7.

FIG. 4 illustrates an example of a device for accelerating a memory operation, according to one or more embodiments.

Referring to FIG. 4, an electronic device 400 may include a processor 401, an offload determinator 410, an instruction generator 420, an instruction transmitter 430, a result receiver 440, and a determination maintainer 450. FIG. 4 illustrates the processor 401, the offload determinator 410, the instruction generator 420, the instruction transmitter 430, the result receiver 440, and the determination maintainer 450 separately and illustrates the operations of each of the offload determinator 410, the instruction generator 420, the instruction transmitter 430, the result receiver 440, and the determination maintainer 450 separately, but the electronic device 400 may individually and/or parallelly control each of the offload determinator 410, the instruction generator 420, the instruction transmitter 430, the result receiver 440, and the determination maintainer 450 through the processor 401.

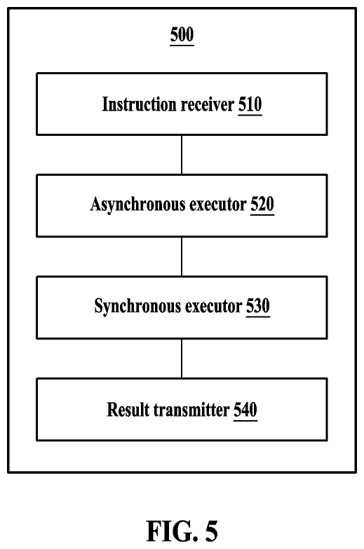

For example, in response to detecting the memory operation, the offload determinator 410 may determine whether to offload the memory operation to a memory device based on a memory size corresponding to the memory operation. An example of the structure of the memory device is described in detail below with reference to FIG. 5.

For example, the memory operation may be/include a CXL memory operation, and the memory device may be a CXL memory device.

For example, the offload determinator 410 may determine whether the memory size corresponding to the memory operation exceeds a first threshold value and may offload the memory operation to the memory device when the memory size corresponding to the memory operation exceeds the first threshold value. For example, the offload determinator 410 may represent additional hardware that communicates with the processor 401 in a wired and/or wireless manner.

For example, the offload determinator 410 may determine not to offload the memory operation to the memory device when the memory size corresponding to the memory operation is less than or equal to the first threshold value. Additionally, the electronic device 400 may include the determination maintainer 450 and may determine not to offload the memory operation to the memory device when the memory size corresponding to the memory operation is less than or equal to the first threshold value based on the determination maintainer 450.

For example, the instruction generator 420 may generate instructions corresponding to the memory operation.

For example, when it is determined to offload the memory operation to the memory device, the instruction generator 420 may generate first processing instructions configured for batch processing the memory operation, and may do so based on a batch flag corresponding to the memory operation being a first flag value. In addition, the instruction generator 420 may generate second processing instructions corresponding to not batch processing the memory operation, based on the batch flag corresponding to the memory operation being a second flag value. The instruction generator 420 may determine an offload mode for each of the processor 401 and the memory device of the memory operation.

For example, the instruction generator 420 may determine whether the memory size corresponding to the memory operation exceeds a second threshold value. In response to the memory size corresponding to the memory operation exceeding the second threshold value, the instruction generator 420 may determine that the memory device uses a first offload mode when offloading the memory operation to the memory device and may generate/set a first offload mode flag value corresponding to the memory operation. In response to the memory size corresponding to the memory operation being less than or equal to the second threshold value, the instruction generator 420 may determine that the memory device uses a second offload mode when offloading the memory operation to the memory device and may generate/set a second offload mode flag value corresponding to the memory operation.

For example, the instruction transmitter 430 may transmit, to the memory device, the instructions corresponding to the memory operation.

For example, the instruction transmitter 430 may transmit the first processing instructions and the offload mode flag to the memory device based on the batch flag corresponding to the memory operation being the first flag value. Additionally, the instruction transmitter 430 may transmit the second processing instructions and the offload mode flag to the memory device based on the batch flag corresponding to the memory operation being the second flag value.

For example, the result receiver 440 may receive, from the memory device, an execution result corresponding to the memory operation performed based on the instructions.

FIG. 5 illustrates an example of an electronic device for accelerating a memory operation, according to one or more embodiments.

Referring to FIG. 5, an electronic device 500 (e.g., the electronic device 400 of FIG. 4) may include an instruction receiver 510, an asynchronous executor 520, a synchronous executor 530, and a result transmitter 540 all included in a memory device.

For example, the instruction receiver 510 may receive, from a processor (e.g., the processor 401 of FIG. 4), instructions corresponding to a memory operation.

For example, the electronic device 500 may further include an instruction decoder that acquires decoding instructions of the memory operation by decoding the instructions corresponding to the memory operation. For example, based on the instructions corresponding to the memory operation including first processing instructions, the instruction decoder may acquire encoding instructions of the memory operation by batch processing the first processing instructions. For example, the instruction decoder may acquire decoding instructions of the memory operation by decoding the encoding instructions of the memory operation. Based on the instructions corresponding to the memory operation including second processing instructions, the instruction decoder may also acquire decoding instructions of the memory operation by decoding the second processing instructions.

For reference, the memory operation may be a CXL memory operation.

For example, the asynchronous executor 520 may acquire a first execution result by executing, by the memory device, the memory operation in an asynchronous mode, based on the instructions transmitted from the processor to the memory device including a first offload mode flag. In the asynchronous mode, results may be returned to the host/CPU with a timing determined by the memory device, and the host/CPU may generate an interrupt to receive the results.

For example, the asynchronous executor 520 may be configured to execute the asynchronous mode for the decoding instructions of the memory operation.

For example, the synchronous executor 530 may be configured to acquire a second execution result by executing, by the memory device, the memory operation in a synchronous mode, based on the instructions transmitted from the processor to the memory device including a second offload mode flag value.

For example, the synchronous executor 530 may be configured to execute the synchronous mode for the decoding instructions of the memory operation.

For example, the result transmitter 540 may transmit, to the processor, either the first execution result or the second execution result, which has been generated.

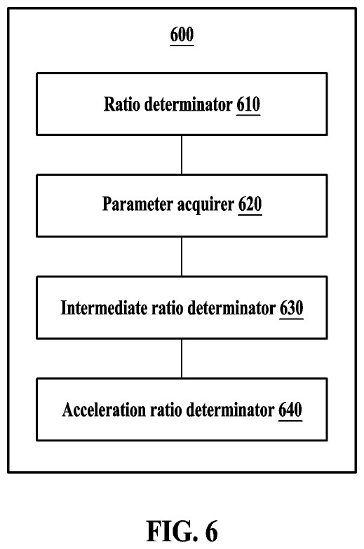

FIG. 6 illustrates an example of an electronic device, according to one or more embodiments.

An electronic device 600 (e.g., the electronic device 400 of FIG. 4 and the electronic device 500 of FIG. 5) may evaluate a memory operation acceleration method.

Referring to FIG. 6, the electronic device 600 may include a ratio determinator 610, a parameter acquirer 620, an intermediate ratio determinator 630, and an acceleration ratio determinator 640.

For example, when the electronic device 600 performs a computation, the ratio determinator 610 may determine a first ratio of an execution time of functions (e.g., target system functions) corresponding to each computation to an execution time of all functions (e.g., all system functions) and a second ratio of an execution time of accelerated functions among the target system functions to an execution time of all the functions (e.g., all system functions).

For example, the parameter acquirer 620 may acquire a frequency coefficient of a processor (e.g., a CPU), system memory pressure, and acceleration coefficients corresponding to the accelerated functions.

For example, the intermediate ratio determinator 630 may determine a third ratio based on the first ratio, the second ratio, and the acceleration coefficients corresponding to the accelerated functions.

For example, the third ratio may be defined by Equation 5 below.

$$Third Ratio = \frac{1}{1 - ( 1 - \frac{1}{∝} ) * {ratio}_{sys \_ func} * {ratio}_{mem \_ op}} \qquad Equation 5$$

In Equation 5, ratio_{sys_func} denotes a first ratio, ratio_{mem_op} denotes a second ratio, and ∝ denotes an acceleration coefficient of an accelerated function. Here, ∝ may be defined as shown in Equation 6 below.

$$∝ = \frac{{t}_{ori \_ mem \_ op}}{{t}_{acc \_ mem \_ op}} , ∝ ∈ ( 0 , + ∞ ) \qquad Equation 6$$

In Equation 6, t_{ori_mem_op}=tₒᵣᵢ−t_{ori_other}, t_{acc_mem_op}=t_{acc}−t_{acc_other}, and t_{acc_other}=t_{ori_other}. Here, t_{ori_mem_op} denotes an execution time of an accelerated function before accelerating the accelerated function and tor denotes the total execution time of all functions before accelerating the accelerated function. In addition, t_{ori_other} denotes an execution time of functions other than accelerated functions among all functions before acceleration. t_{acc_mem_op} denotes an execution time after accelerating the accelerated function, t_{acc} denotes the total execution time of all functions after accelerating the accelerated function, and t_{acc_other} denotes an execution time of functions other than the accelerated functions among all functions after accelerating the accelerated function.

For example, the acceleration ratio determinator 640 may determine a result of multiplication of the frequency coefficient of the processor (e.g., a CPU), the system memory pressure, and the third ratio to be an acceleration ratio of the memory operation of the electronic device 600 (e.g., a system). For example, the memory operation may include a memory copy task and/or a memory set task performed by the electronic device 600.

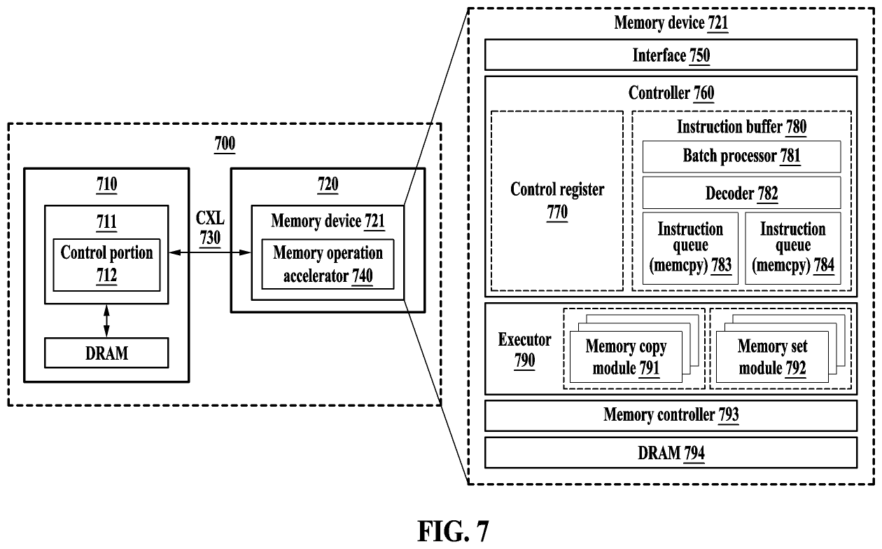

FIG. 7 illustrates an example of an electronic device including a processor and a memory device, according to one or more embodiments.

As illustrated in FIG. 7, an electronic device 700 may include nodes 710 and 720. For example, the nodes 710 and 720 may each represent a device including a memory (e.g., DRAM) and a processor (e.g., a CPU, a graphics processing unit (GPU), a neural processing unit (NPU), or the like). However, a configuration of the nodes 710 and 720 is not limited thereto. First node 710 forming the electronic device 700 may include a processor 711. The processor 711 may include a control portion 712 for executing intelligent policies (e.g., performance optimization, power management, memory access control, and memory operation acceleration). For example, the processor 711 may execute a method of accelerating a memory operation through the control portion 712. As illustrated in FIG. 7, second node 720 may include a memory device 721. The memory device 721 (e.g., a CXL memory device) may include a memory operation accelerator 740. The memory device 721 may be connected to the processor 711 based on a CXL 730. Additionally, the memory device 721 may include an interface 750, a controller 760, and DRAM 794. The memory device 721 may execute the method of accelerating the memory operation through the memory operation accelerator 740. As illustrated in FIG. 7, the memory operation accelerator 740 may include the controller 760, which includes a control register 770 and an instruction buffer 780, and an executor 790, which includes a memory copy module 791 and a memory set module 792. For example, the control register 770 may initialize the memory operation accelerator 740. The instruction buffer 780 may process batch instructions and may decode instructions. For example, the instruction buffer 780 may include a batch processor 781 that combines instructions to be batch-processed among instructions transmitted from the first node 710 to the second node 720. The instruction buffer 780 may decode the instructions transmitted from the first node 710 to the second node 720 based on a decoder 782 (e.g., an operation code (OPCODE) decoder). The instruction buffer 780 may include, among the instructions transmitted from the first node 710 to the second node 720, an instruction queue 783 that performs pending instructions related to a memory copy and an instruction queue 784 that performs pending instructions related to a memory set. The memory copy module 791 may execute a memory copy task in parallel. Additionally, the memory set module 792 may execute a memory set task in parallel. The executor 790 may execute the memory operation acceleration method described with reference to FIGS. 1 to 6.

For reference, the memory device 721 may include a device implemented by processing near memory (PNM) technology. For example, the memory device 721 may include a memory area to store data. The memory area may be an area (e.g., a physical area) where data may be read from and/or written in a memory chip of the physical memory device. The memory area may be disposed in a memory die (or a core die) of the memory device 721. The memory device 721 may cooperate with the processor 711 to process data in the memory area. For example, the memory device 721 may perform computations or processing on data based on instructions or commands received from the processor 711. The memory device 721 may control the memory area in response to the instructions or commands of the processor 711. For example, the memory device 721 may be included in the electronic device 700 and separated from the processor 711. For reference, the processor 711 may oversee/control the entire computation of the electronic device 700 and delegate a computation requiring acceleration (e.g., processing-in-memory (PIM)) to the memory device 721.

The electronic device 700 (e.g., a non-transitory computer-readable storage medium) may store a computer program. For example, the electronic device 700 may implement the memory operation acceleration method described with reference to FIGS. 1 to 6 by executing the computer program.

For example, the electronic device 700 (e.g., a non-transitory computer-readable storage medium) may store one or more computer programs. The electronic device 700 may implement the following operations by executing the computer programs. For example, in response to detecting the memory operation, the electronic device 700 may determine to offload the memory operation to the memory device 721 based on a memory size of the memory operation. The electronic device 700 may generate instructions corresponding to the memory operation. The electronic device 700 may transmit the instructions corresponding to the memory operation to the memory device 721. Additionally, the electronic device 700 may transmit an execution result of the memory operation from the memory device 721 to the processor 711.

The electronic device 700 (e.g., a non-transitory computer-readable storage medium) may store one or more computer programs. The electronic device 700 may implement the following operations by executing the computer programs. For example, the electronic device 700 may transmit the instructions corresponding to the memory operation from the processor 711 (e.g., a CPU) to the memory device 721. The memory device 721 may acquire a first execution result by executing the memory operation in an asynchronous mode, based on the instructions corresponding to the memory operation including a first offload mode flag. The memory device 721 may acquire a second execution result by executing the memory operation in a synchronous mode, based on the instructions corresponding to the memory operation including a second offload mode flag. The electronic device 700 may transmit, to the processor 711, at least one of the first execution result or the second execution result.

The electronic device 700 (e.g., a non-transitory computer-readable storage medium) may store one or more computer programs. The electronic device 700 may implement the following operations by executing the computer programs. For example, the electronic device 700 may determine a first ratio of an execution time of target system functions to an execution time of all system functions and a second ratio of an execution time of accelerated functions among the target system functions to an execution time of all the system functions. The electronic device 700 may acquire a frequency coefficient of the processor 711, system memory pressure, and acceleration coefficients corresponding to the accelerated functions. The electronic device 700 may determine a third ratio based on the first ratio, the second ratio, and the acceleration coefficients corresponding to the accelerated functions. The electronic device 700 may determine a result of the multiplication of the frequency coefficient of the processor 711, the system memory pressure, and the third ratio to be an acceleration ratio of the memory operation performed by a system.

For example, a non-transitory computer-readable storage medium may be, but is not limited thereto, an electrical, magnetic, optical, electromagnetic, infrared, or semiconductor system, a device or apparatus, or any combination thereof. More specific examples of the non-transitory computer-readable storage medium may include an electrical connection having one or more conductors, a portable computer disk, a hard disk, RAM, read-only memory (ROM), erasable programmable ROM (EPROM) or flash memory, an optical fiber, a portable CD-ROM, an optical storage device, a magnetic storage device, or any suitable combination thereof. However, examples are not limited thereto. The non-transitory computer-readable storage medium is any type of medium that includes or stores a computer program, wherein the computer program may be used in or combined with an instruction execution system, a device, or an apparatus. The computer program included in the non-transitory computer-readable storage medium may be transmitted through any suitable medium (e.g., a wire, an optical fiber, a radio frequency (RF), or the like or any suitable combination thereof). However, examples are not limited thereto. The non-transitory computer-readable storage medium may be included in any device and may exist independently without being mounted on the device.

Additionally, the electronic device 700 may further include computer program products. The computer program products may be implemented as software or applications. Commands or instructions for driving the computer program products may be executed by the processor 711 of the electronic device 700 to perform the method of accelerating a memory operation, as described with reference to FIGS. 1 to 6.

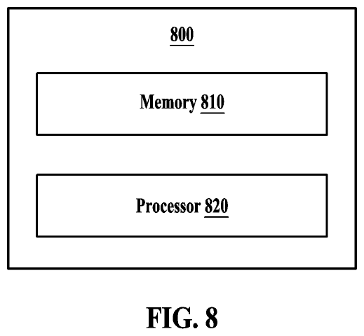

FIG. 8 illustrates an example of an electronic device, according to one or more embodiments.

Referring to FIG. 8, an electronic device 800 may include a memory 810 and a processor 820. The memory 810 may store a computer program and instructions or commands for operating the computer program. The electronic device 800 may accelerate a memory operation when the computer program stored in the memory 810 is executed by the processor 820.

For example, the electronic device 800 may implement the following operations when the computer program is executed by the processor 820. For example, the electronic device 800 may determine to offload the memory operation to a memory device based on a memory size corresponding to the memory operation, in response to detecting the memory operation. The electronic device 800 may generate instructions corresponding to the memory operation. The electronic device 800 may transmit the instructions corresponding to the memory operation to the memory device. Additionally, the electronic device 800 may transmit an execution result of the memory operation from the memory device to the processor 820. For reference, although not directly shown in FIG. 8, the electronic device 800 may include the memory device.

For example, the electronic device 800 may implement the following operations when the computer program is executed by the processor 820. For example, the electronic device 800 may transmit the instructions corresponding to the memory operation from the processor 820 (e.g., a CPU) to the memory device. The memory device may acquire a first execution result by executing the memory operation in an asynchronous mode, based on the instructions corresponding to the memory operation including a first offload mode flag. The memory device may acquire a second execution result by executing the memory operation in a synchronous mode, based on the instructions corresponding to the memory operation including a second offload mode flag. The electronic device 800 may transmit, to the processor 820, at least one of the first execution result or the second execution result.

For example, the electronic device 800 may implement the following operations when the computer program is executed by the processor 820. For example, the electronic device 800 may determine a first ratio of an execution time of target system functions to an execution time of all system functions and a second ratio of an execution time of accelerated functions among the target system functions to an execution time of all the system functions. The electronic device 800 may acquire a frequency coefficient of the processor 820, system memory pressure, and acceleration coefficients corresponding to the accelerated functions. The electronic device 800 may determine a third ratio based on the first ratio, the second ratio, and the acceleration coefficients corresponding to the accelerated functions. The electronic device 800 may determine a result of the multiplication of the frequency coefficient of the processor 820, the system memory pressure, and the third ratio to be an acceleration ratio of the memory operation performed by a system.

The electronic device 800 may be, but is not limited thereto, a mobile phone, a laptop, a personal digital assistant (PDA), a tablet computer, a desktop computer, a compute cluster node, or the like. The electronic device 800 illustrated in FIG. 8 is merely an example and is not intended to suggest any limitation as to the scope of use or functionality of examples of the disclosure.

The examples of the methods and devices for accelerating the memory operation are described with reference to FIGS. 1 to 8. Each of the electronic devices 400, 500, 600, 700, and 800 illustrated in FIGS. 1 to 8 may be implemented by software, hardware, firmware, or any combination thereof to perform predetermined functions. The electronic devices 400, 500, 600, 700, and 800 illustrated in FIGS. 1 to 8 are not limited to including the above-described components, some components may be added or deleted thereto or therefrom as necessary, and components may also be combined.

The computing apparatuses, the electronic devices, the processors, the memories, the information output system and hardware, the storage devices, and other apparatuses, devices, units, modules, and components described herein, including descriptions with respect to respect to FIGS. 1-8, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit (ALU), a digital signal processor (DSP), a microcomputer, a programmable logic controller, a field-programmable gate array (FPGA), a programmable logic array (PLU), a microprocessor, or any other device or combination of devices that is configured to respond to and execute instructions (e.g., code or coding) in a defined manner to achieve a desired result. In one example, a processor or computer includes, or is connected to, one or more memories storing the instructions or software that are executed by the processor or computer. Hardware components implemented by a processor or computer may execute the instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both, and thus while some references may be made to a singular processor or computer, such references also are intended to refer to multiple processors or computers. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing. Thus, references to a processor herein mean processing circuitry (e.g., circuitry that includes one or more processing element(s) circuits). One or more processors comprising processing circuitry also refers to each processor comprising processing circuitry, as well as some or all of the one or more processors comprising the same processing circuitry. In addition, processors(s) and controller(s), as a non-limiting example, do not mean human processing or human control, but rather, refer to hardware components as described herein, as non-limiting examples.

The methods illustrated in, and discussed with respect to, FIGS. 1-8 that perform the operations described in this application are performed by computing hardware, for example, by one or more processors or computers, implemented as described above implementing the instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations. References to a processor, or one or more processors, as a non-limiting example, configured to perform two or more operations refers to a processor or two or more processors being configured to collectively perform all of the two or more operations, as well as a configuration with the two or more processors respectively performing any corresponding one of the two or more operations (e.g., with a respective one or more processors being configured to perform each of the two or more operations, or any respective combination of one or more processors being configured to perform any respective combination of the two or more operations). Likewise, a reference to a processor-implemented method is a reference to a method that is performed by one or more processors or other processing or computing hardware of a device or system.

The instructions or software to control computing hardware, for example, one or more processors or computers, to implement the hardware components and perform the methods as described above may be written as computer programs, code segments, or other executable instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. Thus, references herein to storage media mean storage media hardware, and does not mean to transitory media, nor a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A method of accelerating a memory operation, performed by a processor, the method comprising:
determining whether to offload the memory operation to a memory device based on a memory size corresponding to the memory operation, in response to detecting the memory operation;
generating instructions corresponding to the memory operation in response to determining to offload the memory operation to the memory device;
transmitting the instructions to the memory device; and
receiving, from the memory device, an execution result corresponding to the memory operation performed based on the instructions.

2. The method of claim 1, wherein
the memory operation comprises a computing express link (CXL) memory operation, and
the memory device comprises a CXL memory device.

3. The method of claim 1, wherein the determining of whether to offload the memory operation to the memory device based on the memory size corresponding to the memory operation comprises:
determining whether the memory size corresponding to the memory operation exceeds a first threshold value; and
offloading the memory operation to the memory device in response to the memory size corresponding to the memory operation exceeding the first threshold value.

4. The method of claim 1, further comprising:
determining whether to offload a second memory operation to the memory device based on a memory size corresponding to the second memory operation, in response to detecting the second memory operation;
wherein the second memory operation comprises a computing express link (CXL) memory operation, and the memory device comprises a CXL memory device;
wherein the determining of whether to offload the memory operation to the memory device based on the memory size corresponding to the second memory operation comprises:
determining whether the second memory size corresponding to the second memory operation exceeds the first threshold value; and
determining to not offload the second memory operation to the memory device in response to the memory size corresponding to the second memory operation being less than or equal to the first threshold value.

5. The method of claim 1, wherein the generating of the instructions corresponding to the memory operation comprises:
evaluating a batch flag to select between:
generating first processing instructions corresponding to batch processing the memory operation, based on the batch flag corresponding to the memory operation having a first flag value; and
generating second processing instructions corresponding to not batch processing the memory operation, based on the batch flag corresponding to the memory operation having a second flag value; and
generating an offload mode flag that determines an offload mode for each of the processor and the memory device of the memory operation.

6. The method of claim 5, wherein the generating of the offload mode flag comprises:
determining whether the memory size corresponding to the memory operation exceeds a second threshold value;
evaluating the memory size against the second threshold to select between:
when the memory size corresponding to the memory operation exceeds the second threshold value, determining that the memory device is to use a first offload mode in response to offloading the memory operation to the memory device and generating a first offload mode flag value corresponding to the memory operation; and
when the memory size corresponding to the memory operation is less than or equal to the second threshold value, determining that the memory device is to use a second offload mode in response to offloading the memory operation to the memory device and generating a second offload mode flag value corresponding to the memory operation.

7. The method of claim 5, wherein the transmitting of the instructions to the memory device comprises:
evaluating the batch flag to select between:
transmitting, to the memory device, the first processing instructions and the offload mode flag based on the batch flag corresponding to the memory operation having the first flag value; and
transmitting, to the memory device, the second processing instructions and the offload mode flag based on the batch flag corresponding to the memory operation having the second flag value.

8. The method of claim 1, wherein the receiving, from the memory device, of the execution result corresponding to the memory operation performed based on the instructions comprises:
receiving, by the memory device, the instructions corresponding to the memory operation from the processor;
acquiring, by the memory device, a first execution result by executing the memory operation in an asynchronous mode, when the instructions comprise a first offload mode flag value;
acquiring, by the memory device, a second execution result by executing the memory operation in a synchronous mode, when the instructions comprising a second offload mode flag value; and
receiving, by the processor, either the first execution result or the second execution result.

9. The method of claim 8, further comprising:
acquiring decoding instructions corresponding to the memory operation, based on the memory device decoding the instructions corresponding to the memory operation,
wherein the acquiring, by the memory device, of the first execution result by executing the memory operation in the asynchronous mode comprises executing, by the memory device, the asynchronous mode based on the decoding instructions, and
wherein the acquiring, by the memory device, of the second execution result by executing the memory operation in the synchronous mode comprises executing, by the memory device, the synchronous mode based on the decoding instructions.

10. The method of claim 9, wherein the acquiring of the decoding instructions corresponding to the memory operation comprises:
based on the instructions corresponding to the memory operation comprising first processing instructions, acquiring encoding instructions corresponding to the memory operation by batch processing the first processing instructions; and
acquiring the decoding instructions corresponding to the memory operation by decoding the encoding instructions by the memory device.

11. The method of claim 9, wherein the acquiring of the decoding instructions corresponding to the memory operation comprises, based on the instructions corresponding to the memory operation comprising second processing instructions, acquiring the decoding instructions corresponding to the memory operation by decoding the second processing instructions by the memory device.

12. The method of claim 8, wherein
the memory operation comprises a computing express link (CXL) memory operation, and
the memory device comprises a CXL memory device.

13. The method of claim 1, further comprising:
evaluating a system configured to perform the method, the system comprising the processor and the memory device,
wherein the evaluating of the system comprises:
determining a first ratio of an execution time of target system functions to an execution time of system functions and a second ratio of an execution time of accelerated functions among the target system functions to an execution time of all the system functions;
acquiring a frequency coefficient of the processor, system memory pressure, and acceleration coefficients of the accelerated functions;
determining a third ratio based on the first ratio, the second ratio, and the acceleration coefficients of the accelerated functions; and
determining a result of multiplication of the frequency coefficient of the processor, the system memory pressure, and the third ratio to be an acceleration ratio of the memory operation performed by the system.

14. A non-transitory computer-readable storage medium storing instructions,
wherein, the instructions, when executed by a computing device, cause the computing device to perform a process comprising:
in response to detecting a memory operation, determining whether to offload the memory operation to a memory device based on a memory size corresponding to the memory operation;
generating instructions corresponding to the memory operation in response to determining to offload the memory operation to the memory device;
transmitting the instructions to the memory device; and
receiving, from the memory device, an execution result corresponding to the memory operation performed based on the instructions.

15. An electronic device for accelerating a memory operation based on a processor, the electronic device comprising:
an offload determinator configured to determine whether to offload the memory operation to a memory device based on a memory size corresponding to the memory operation, in response to detecting the memory operation;
an instruction generator configured to generate instructions corresponding to the memory operation in response to determining to offload the memory operation to the memory device;
an instruction transmitter configured to transmit the instructions to the memory device; and
a result receiver configured to receive, from the memory device, an execution result corresponding to the memory operation performed based on the instructions.

16. The electronic device of claim 15, wherein the offload determinator is configured to determine whether the memory size corresponding to the memory operation exceeds a first threshold value and is configured to offload the memory operation to the memory device in response to the memory size corresponding to the memory operation exceeding the first threshold value.

17. The electronic device of claim 16, wherein the process further comprises:
determining whether to offload a second memory operation to the memory device based on a memory size corresponding to the second memory operation, in response to detecting the second memory operation;
wherein the second memory operation comprises a computing express link (CXL) memory operation, and the memory device comprises a CXL memory device;
wherein the determining of whether to offload the memory operation to the memory device based on the memory size corresponding to the second memory operation comprises:
determining whether the second memory size corresponding to the second memory operation exceeds the first threshold value; and
wherein the offload determinator is further configured to determine to not offload the second memory operation to the memory device in response to the memory size corresponding to the memory operation being less than or equal to the first threshold value.

18. The electronic device of claim 15, wherein the instruction generator is configured to:
evaluate a batch flag to select between:
generating first processing instructions corresponding to batch processing the memory operation, based on the batch flag corresponding to the memory operation having a first flag value, and
generating second processing instructions corresponding to not batch processing the memory operation, based on the batch flag corresponding to the memory operation having a second flag value, and
wherein the instruction generator is further configured to generate an offload mode flag that determines an offload mode for each of the processor and the memory device of the memory operation.

19. The electronic device of claim 18, wherein the instruction generator is configured to determine whether the memory size corresponding to the memory operation exceeds a second threshold value, and
evaluate the memory size against the second threshold to select between:
when the memory size corresponding to the memory operation exceeds the second threshold value, determine that the memory device is to use a first offload mode in response to offloading the memory operation to the memory device and generate a first offload mode flag value corresponding to the memory operation, and
when the memory size corresponding to the memory operation is less than or equal to the second threshold value, determine that the memory device is to use a second offload mode in response to offloading the memory operation to the memory device and generate a second offload mode flag value corresponding to the memory operation.

20. The electronic device of claim 15, further comprising:
a memory device,
wherein the memory device comprises:
an instruction receiver configured to receive, from the processor, the instructions corresponding to the memory operation;
an asynchronous executor configured to acquire, by the memory device, a first execution result by executing the memory operation in an asynchronous mode, when the instructions comprise a first offload mode flag value;
a synchronous executor configured to acquire, by the memory device, a second execution result by executing the memory operation in a synchronous mode, when the instructions comprising a second offload mode flag value; and
a result transmitter configured to transmit, to the processor, either the first execution result or the second execution result.
